(19) United States
(12) Patent Application Publication
(10) Pub. No.: US 2026/0344687 A1
(43) Pub. Date: Nov. 5, 2026

(54) HALOGENATED COMPOUND-COATED MATERIALS AND USES THEREOF IN FOOD SPOILAGE CONTROL

(71) Applicant: MedeSol Global, Inc., Las Vegas, NV (US)

(72) Inventor: Jeffery F. Williams, Langley, WA (US)

(21) Appl. No.: 19/651,490

(22) Filed: Apr. 17, 2026

Related U.S. Application Data
(60) Provisional application No. 63/790,870, filed on Apr. 18, 2025.

(51) Int. Cl. A23B 2/721; A23B 7/152; B65D 81/20

(52) U.S. Cl. CPC A23B 2/721; A23B 7/152; B65D 81/2084

(57) ABSTRACT

The disclosure provides halogenated compound-coated materials including chlorinated compound-coated materials. The disclosure further provides a method of reducing food spoilage by placing a chlorinated compound-coated material in an environment of a perishable food item, wherein the chlorinated compound-coated material includes a chlorinated compound coated on an substrate material, in an amount sufficient to result in release of chlorine gas and hypochlorous acid, but not chlorine dioxide from the chlorinated compound-coated material; depleting ethylene in the environment of the perishable food item by reaction with the chlorine gas and hypochlorous acid, or a chlorinated composition formed therefrom; and hampering growth of at least one microbial species in the environment of the perishable food item by exposure of the microbial species to the chlorine gas and hypochlorous acid, or a chlorinated composition formed therefrom.

### TECHNICAL FIELD

The present disclosure relates to halogenated compound-coated materials. The present disclosure further relates to the use of such materials to control food spoilage, for example in a dual-functional manner, by controlling bacterial growth and by controlling levels of ethylene in the food's environment, such as packaging.

### BACKGROUND

Food spoilage results in tremendous amounts of waste, which negatively impact both the environment and food affordability. Food contamination presents significant medical risks, with food poisoning resulting in thousands of hospitalizations and even deaths, particularly in young children, each year. Despite efforts to slow and reduce food spoilage and food contamination dating back nearly as long as human civilization has existed, and the dedication of hundreds of millions of dollars and entire scientific careers to these efforts in modern times, food spoilage remains a common and significant problem.

In addition, some methods of reducing food spoilage, while effective, have associated risks that hamper their use. Many chemicals that could help with food preservation can also pose significant dangers. For example, many potential food preservation chemicals produce chlorine dioxide, a gas which, while quite effective at controlling microbial growth and safe for humans to ingest at low concentrations, is also potentially explosive and fatal if ingested in higher amounts.

### SUMMARY

In some embodiments, the disclosure provides an:

Embodiment 1, including method of reducing food spoilage or food contamination comprising placing a chlorinated compound-coated material in an environment of a perishable food item, wherein the chlorinated compound-coated material comprises a chlorinated compound coated on an substrate material, in an amount sufficient to result in release of chlorine gas and hypochlorous acid, but not chlorine dioxide from the chlorinated compound-coated material; depleting ethylene in the environment of the perishable food item by reaction of ethylene with the chlorine gas, hypochlorous acid, or a chlorinated composition formed therefrom; and hampering growth of at least one microbial species in the environment of the perishable food item by exposure of the microbial species to the chlorine gas, hypochlorous acid, or a chlorinated composition formed therefrom.

In additional embodiments, each of which are numbered as below, the disclosure provides:

Embodiment 2. The method of embodiment 1, wherein the chlorinated compound coated on the substrate material comprises a chlorinated imidazolidinedione or imidazolidinone, or any combination thereof.

Embodiment 3. The method of embodiment 2, wherein the chlorinated imidazolidinedione or imidazolidinone comprises a chlorinated hydantoin.

Embodiment 4. The method of any one of embodiments 2-3, wherein the chlorinated imidazolidinedione comprises monochlorodimethylhydantoin (MCDMH), dichlorodimethylhydantoin (DCDMH), or any combinations thereof.

Embodiment 5. The method of any one of embodiments 2-4, wherein the chlorinated imidazolidinone comprises monchlorotetramethylimidazolidine-4-one (MC).

Embodiment 6. The method of any one of embodiment 1-5, wherein the substrate material comprises a zeolite, bentonite, perlite, vermiculite, sand, alum, fibrous organic materials, superabsorbent polymer, polyacrylate, other organic or inorganic material, or any combinations thereof.

Embodiment 7. The method of any one of embodiment 6, wherein the substrate material comprises a zeolite, bentonite, vermiculite, perlite, or any combinations thereof.

Embodiment 8. The method of any one of embodiments 1-7, wherein placing the chlorinated compound-coated material in the environment of the perishable food item comprises placing a gas-permeable container comprising the chlorinated compound-coated material in the environment of the perishable food item.

Embodiment 9. The method of any one of embodiments 1-8, wherein the environment of the perishable food item comprises a sealed, vented, or enclosed package containing the perishable food item.

Embodiment 10. The method of any one of embodiments 1-9, wherein ethylene concentration in the air within six inches of the food is reduced by at least 60% within 24 hours after placement of the chlorinated compound-coated material.

Embodiment 11. The method of embodiment 9, wherein the ethylene concentration in the sealed or enclosed package is reduced by at least 60% within 24 hours after placement of the chlorinated compound-coated material.

Embodiment 12. The method of any one of embodiments 10-11, wherein the ethylene reduction remains at least 60% for at least 48 hours after placement of the chlorinated compound-coated material.

Embodiment 13. The method of any one of embodiments 1-12, wherein the ethylene reduction slows ethylene-ripening-based spoilage of the perishable food item.

Embodiment 14. The method of any one of embodiments 1-13, wherein the ethylene reduction slows ethylene-based ripening of the perishable food item.

Embodiment 15. The method of any one of embodiments 1-13, wherein the microbe comprises a bacteria.

Embodiment 16. The method of embodiment 15, wherein the bacteria comprises E. coli, L. innocua, L. monocytogenes, S. aureus, Salmonella, or any combinations thereof.

Embodiment 17. The method of any one of embodiments 1-16, wherein the perishable food item comprises a fruit or vegetable.

Embodiment 18. The method of any one of embodiments 1-16, wherein the perishable food item comprises a meat, fish, or shellfish.

Embodiment 19. The method of any one of embodiments 1-18, wherein the environment of the perishable food item has a humidity of at least 20%.

Embodiment 20. The method of any one of embodiments 1-19, wherein the environment of the perishable food item has a temperature of at least 4 °C.

### BRIEF DESCRIPTION OF THE DRAWINGS

The disclosure may be further understood through reference to the following figures, which represent embodiments of the disclosure.

FIG. 1 is a graph illustrating comparative effects of potassium permanganate-coated zeolite granules (Permanganate) or MCMDH-coated zeolite granules (MCMDH Zeolite) on ethylene concentration in a closed vial (control contained no granules).

FIG. 2 is a photograph of nutrient agar plates showing bacterial growth after such plates were incubated in packaging with uncoated zeolite granules (two plates labelled C), or 2, 5, or 10 g of DCDMH-coated zeolite granules (2 plates labelled 2, plate labelled 5, and plate labelled 10, respectively).

FIG. 3 is a photograph of nutrient agar plates showing Listeria growth after such plates were incubated in packaging with 2 g of DCDMH coated zeolite granules (2 g-11994) or no zeolite granules (0 g-11994). Cross lines in the 2 g sample indicate non-Listeria colonies that were incidental contaminants.

FIG. 4 is a photograph of nutrient agar plates showing bacterial growth after such plates were incubated in packaging with uncoated zeolite granules (plate labelled C), or 750 mg of DCDMH-coated zeolite granules (plate labelled T).

FIG. 5 is a photograph of nutrient agar plates showing bacterial growth after such plates were exposed to microbes washed from fresh blueberries and incubated in packaging with uncoated zeolite granules (plate labelled C), or 2 g of DCDMH-coated zeolite granules (plate labelled T).

FIG. 6 is a graph illustrating comparative effects of MCMDH-coated zeolite granules (Zeolite-MCMDH), MC-coated zeolite granules (Zeolite-MC), or DCDMH-coated zeolite granules (Zeolite-DCDMH) on ethylene concentration in a closed vial (controls contained uncoated granules).

FIG. 7 is a graph illustrating comparative effects of three commercial permanganate ethylene control products (Samples A, B, and C) on ethylene concentration in a closed vial (control contained no material).

### DETAILED DESCRIPTION

The present disclosure relates to halogenated compound-coated materials. Although the embodiments presented herein contain chlorine (Cl) as the halogen, in other embodiments other halogens may be used in place of chlorine. In some embodiments, the halogenated compound may include a chlorinated imidazolidinedione or imidazolidinone, or a combination thereof. The chlorinated compound, in the presence of water, is hydrolyzed to eventually result in release of chlorine gas (Cl₂) and hypochlorous acid (HOCl). Suitable substrate materials, which are coated with the halogenated compound, include zeolite, bentonite, perlite, vermiculite, sand, alum, fibrous organic materials, superabsorbent polymer, polyacrylate, other organic or inorganic material, or any combinations thereof. A halogenated compound may be coated on the substrate material using any of a variety of methods that result in chemical bonding or charge attraction sufficient to physically retain the halogenated compound on the surface of the substrate material, while allowing its reaction with the air, particularly water in the air.

The present disclosure further relates to the use of such halogenated compound-coated materials to control food spoilage and food contamination, for example in a dual-functional manner, by controlling bacterial or other microbial growth and by controlling levels of ethylene in the food's environment, such as packaging. In particular, the chlorinated imidazolidinedione or imidazolidinone may release both chlorine gas (Cl₂) and hypochlorous acid (HOCl) or derivates thereof into the atmosphere surrounding the chlorinated compound-coated material. These chemicals react with ethylene and with bacteria or other microbes to chemically change the ethylene and kill the bacteria or other microbes. Accordingly, if a chlorinated compound-coated material of the present disclosure is present near food, for example in sealed packaging, chlorine gas (Cl₂) and hypochlorous acid (HOCl) are released into the air in the environment surrounding the food and reduce ethylene and kill microbes in that environment. In some embodiments, the chlorinated imidazolidinedione or imidazolidinone may not release detectable levels of chlorine dioxide, such as levels above 1 ppb. In some embodiments, the halogenated compound-coated materials may not contain or release hypochlorites.

### Halogenated Compound-Coated Materials

The halogenated compound-coated materials, particularly chlorinated compound-coated materials of the present disclosure may include a chlorinated imidazolidinedione or imidazolidinone coated on a substrate material, such as zeolite, bentonite, perlite, vermiculite, sand, alum, fibrous organic materials, superabsorbent polymer, polyacrylate, other organic or inorganic material, or any combinations thereof.

Suitable coatings include a chlorinated imidazolidinedione, imidazolidinone, and any combination thereof. In the case of combinations of coating with different halogens, all compounds may contain the same halogen, or they may contain different halogens, such as all chlorinated compounds, all brominated compounds, or a combination of chlorinated and brominated compounds.

In some embodiments, the chlorinated imidazolidinedione or imidazolidinone may include a chlorinated hydantoin.

In some embodiments, the chlorinated imidazolidinedione may include monochlorodimethylhydantoin (MCDMH), dichlorodimethylhydantoin (DCDMH), or any combinations thereof.

In some embodiments, the chlorinated imidazolidinone may include monchlorotetramethylimidazolidine-4-one (MC).

In some embodiments the chlorinated coating may include monochlorodimethylhydantoin (MCDMH), dichlorodimethylhydantoin (DCDMH), monchlorotetramethylimidazolidine-4-one (MC), or any combinations thereof.

In some embodiments the coating may include other chlorinated heterocyclic compounds, chloramines, or any combinations thereof. In some embodiments, the coating may include N chloro taurine. N chloro taurine may also be formed from reaction of the chlorinated compound.

In some embodiments, the substrate material may include a material having a pH of between any including any two of: 2, 2.5, 3, 3.5, 4, 4.5, 5, 5.5, 6, 6.5, and 7. In some embodiments. In some embodiments, the substrate material may be treated to attain this pH, for example by chemical reaction or modification or by coating with or filling by an acidic compound.

In some embodiments, the substrate material may include an inorganic material, particularly a clay, such as a zeolite, bentonite, vermiculite, perlite, sand, or alum, or any combinations thereof. In some embodiments, the substrate material may include a clinoptiloite zeolite

In some embodiments, the substrate material may include a superabsorbent polymer or fiber, such as a polyacrylate.

In some embodiments, the substrate material may include an organic material, such as wood, pulp fiber, corn cob, other organic fibers or particles, or any combinations thereof.

In some embodiments, the chlorinated compound-coated material may be in the form of a particle or fiber. In some embodiments, the particle or fiber may be aggregated. In some embodiments, the chlorinated compound-coated material particle, fiber, particle aggregate, or fiber aggregate may have a minimum average particle diameter or a minimum average fiber cross-sectional diameter of 0.05, 0.1, 0.2, or 0.3 cm or more. In general the chlorinated compound-coated material particles, fibers, or aggregates may be large enough to be easily noticeable if accidentally misplaced onto a nearby food.

In some embodiments, the chlorinated compound-coated material may be provided in a gas-permeable container, such as a bag or rigid container, particularly with dimensions suitable for placement in food packaging, and made from a food-safe material.

In some embodiments, the chlorinated compound-coated material may be provided in an absorbent pad. In such embodiments the chlorinated compound may be coated onto a superabsorbent substrate material, which also provides absorbent features to the pad. The absorbent pad may also include absorbent materials not coated with a chlorinated-compound. In some embodiments, the absorbent pad may be gas permeable on only one side, with the other side being non-gas permeable or waterproof.

In some embodiments, the chlorinated compound-coated material may be formed by exposing the substrate material to a solution of a chlorinated compound as disclosed herein in an alcohol, such as ethanol, followed by drying the solution such that the chlorinated compound remains on the surface of the substrate material. One such process is described in US 2023/040482, which is incorporated by reference herein in its entirety.

### Food Spoilage and Food Contamination Control

The disclosure further provides methods of using a chlorinated compound-coated material as disclosed herein to control spoilage of a food, such as a perishable food. The disclosure further provides methods of using a chlorinated compound-coated material as disclosed herein to control contamination of food with dangerous microbes.

### Ethylene Control

In some embodiments, the food may be a food for which environmental ethylene contributes to spoilage, in particular an ethylene-ripening fruit or vegetable. These fruits and vegetables, when exposed to ethylene gas, undergo changes associated with ripening in response to the gas. Although ripening is often desirable for flavor and other purposes, when a fruit or vegetable is too ripe, it may begin to break down and no longer be palatable or it may provide a better substrate for harmful bacterial growth than its unripened version. This leads to spoilage and waste of the fruit or vegetable, or may facilitate contamination to levels where the food is dangerous to consume.

In some embodiments, a chlorinated compound-coated material of the present disclosure may be placed in the environment of a food in an amount sufficient to reduce ethylene concentration in the air within six inches of the food by at least of between any of the following percentages: 60%, 65%, 70%, 75%, 80%, 85%, 90%, 95%, and 99%, within 24 hours after placement of the chlorinated compound-coated material in the environment of the food. In some embodiments, ethylene may not be detectable (less than 1 ppb) after 24 hours.

In some embodiments, within 1 hour, 4 hours, 6 hours, 12 hours, or 24 hours of placement of the chlorinated compound-coated material in the environment of the food both chlorine gas and the hypochlorous acid may be detectable in air within six inches of the food or in any package. In some embodiments, the chlorinated compound, particularly DCDMH, if present, or any other coating able to sublimate from the chlorinated compound-coated material, may also be detected in the air. However, chlorine dioxide may not be detectable in the air within these time frames or even for longer time frames, such as 72 hours, 96 hours, 1 week, 2 weeks, 1 month, or the shelf-life of the food.

In some embodiments, the chlorinated compound of the chlorinated compound-coated material may form halogen gas chlorine gas and hypochlorous acid in response to water in the environment. Chlorine gas or hypochlorous acid then reacts with ethylene in the air to chemically change the ethylene to any of a number of reaction products, particularly reaction products that do not cause fruit or vegetable ripening or that cause such ripening much more slowly, or that cause harmful ethylene-based effects in other foods or only at higher concentrations as compared to ethylene.

Although fruits and vegetables are common foods that undergo spoilage in response ethylene, other foods may also be harmed by ethylene and methods may include using chlorinated compound-coated material to reduce or remove ethylene from the environment of such foods as well.

Furthermore, although the discussion above focuses on spoilage, as noted, ethylene is also associated with ripening. Accordingly, the methods of the present disclosure may also be used to halt or slow ripening, such as during shipment of fruits or vegetables. In other foods, beneficial effects or ethylene may time-delayed in a similarly advantageous manner.

### Microbial Control

In some embodiments the chlorine gas, hypochlorous acid, or both in the air surrounding the food may also have an antimicrobial effect. In some embodiments, this antimicrobial effect may be dependent on the presence of humidity in the air, such that, within 6 inches of the food or in any package, in some embodiments the air may have at least 20%, 30%, 40%, 50%, 60%, 70%, 80%, or 90% humidity (measured at 4 °C). In some embodiments, the food may itself, such as a fruit, vegetable, meat, fish, or shellfish, may release sufficient humidity, particularly in a sealed container, to provide a humidity level sufficient for the chlorine gas, hypochlorous acid, or both to exert an antimicrobial effect.

In some embodiments, the antimicrobial effect includes killing or hampering growth of a microbe such as bacteria, a fugus, a virus, or any combinations thereof. The microbe may be located on the food or otherwise in a package containing the food.

In some embodiments, the bacteria may include E. coli, L. innocua, L. monocytogenes, S. aureus, Salmonella, and any combinations thereof. In some embodiments, the bacteria may include any detected in a water supply used to water, wash, or package the food, such as a municipal water supply.

In some embodiments, the fungus may include a yeast, mold, or any combinations thereof.

In some embodiments, the virus may include norovirus.

In some embodiments, the antimicrobial effect includes killing or hampering growth of E. coli, L. innocua, L. monocytogenes, S. aureus, Salmonella, yeast, mold, norovirus, or any combinations thereof.

In some embodiments, the antimicrobial effect is observed within 1 hour, 4 hours, 6 hours, 12 hours, 24 hours, or 48 hours of introducing the chlorinated compound-coated material to the environment of the food, at average temperatures of 4 °C, 20 °C, 25 °C, or 37 °C. In some embodiments, the antimicrobial effect is demonstrated by the microbe being undetectable using a swab and growth assay, such as any assay of the Examples.

In some embodiments, the antimicrobial effect may slow or prevent spoilage of the food, for example by killing or slowing growth of bacteria, mold, and other fungus.

In some embodiments, the antimicrobial effect may reduce or contamination of the food, for example by killing and slowing the growth of harmful contaminant bacteria, or by destroying harmful viruses, such as noroviruses.

### Packaging and Use

In some embodiments the chlorinated compound-coated material maybe provided in a package with the food, and may achieve ethylene reductions or microbial control in the package. In some embodiments the package may be sealed or enclosed, such as a sealable bag, plastic container with a lid, or clamshell or similar container, such as are commonly used for fruits and vegetables. In some embodiments, the package may include an absorbent material, such as a superabsorbent polymer, which may be the substrate material for the chlorinated compound-coated material. In some such embodiments, the absorbent material may be provided in a pad, such as those commonly used with meats fish, or shellfish. In some such embodiments, the absorbent material may be in a packet, similar to silica gel packets (in non-food material, but adaptable in format for food use).

In some embodiments, the environment of the food may include an entire storage unit, such as a refrigerator, other refrigeration unit, display case, or refrigerator drawer. In such embodiments, the storage unit may be considered the packaging, and may contain multiple different foods. Typically all foods will benefit from the chlorinated compound-coated material, but embodiments also include situations where only some foods in the storage unit benefit. Pads containing chlorinated compound-coated material, gas-permeable plastic containers, such as decorative containers, or sachets may be used in entire storage until methods.

In some embodiments, the method includes placing at least or between the following amounts of chlorinated compound-coated material in the environment of the food: 500 mg, 1 g, 1.5 g, 2 g, 2.5 g, 3 g, 4, g, 5 g, 6 g, 7 g, 7.5 g, 8 g, 9 g, 10 g, or 15 g. In some embodiments, the method includes placing such an amount of chlorinated compound-coated material in a package, including a sealed package, a vented package, or another enclosed package.

In some embodiments, any of the above effects that occur with the specified time of the chlorinated compound-coated material being placed in the environment of the food may persist for a time of at least or between any of the following: 18 hours, 48 hours, 72 hours, 96 hours, 1 week, 2 weeks, and 1 month.

In some embodiments, the chlorinated compound-coated material effects are observed even though chlorine gas and hypochlorous acid concentration in the air in the relevant times and locations does not exceed 4 ppm. For example, concentration of chlorine gas or hypochlorous acid in the air of the environment of the food may be between 0.1 and 4 ppm, 0.5 and 4 ppm, 1 and 4 ppm, 2 and 4 ppm, or 3 and 4 ppm at the end of the relevant time, or on average during the relevant time.

As explained above, ethylene reduction may prevent or slow spoilage, premature ripening, or both, particularly in fruits and vegetables. Antimicrobial effects are beneficial and occur regardless of whether spoilage or premature ripening is being prevented or slowed, as microbial growth leads to spoilage and can be dangerous at any time.

In some embodiments, methods of disposing of the halogenated compound-coated materials are also provided. In particular, such methods may include simply depositing the material in household or other waste receptacles. Due to the absence of chlorine dioxide formation, special handling to avoid hazards should not be necessary.

### EXAMPLES

### Example 1

The presence of active chlorine volatilized from a chlorinated compound-coated material in a seal container was measured. Clinoptilolite zeolite granules were modified according to the method described in US 2023/0404821, by exposing them to a solution of monochlorodimethylhydantoin (MCDMH) or dichlorodimethylhydantoin (DCDMH) in ethanol at 1% and air drying them so as to deposit the halogenated hydantoin into and onto the zeolite. Five grams of each of the coated zeolite granules were placed 25 mL glass beakers at room temperature and sealed with parafilm. After 12 hours a chlorine detection colorimetric indicator strip was introduced into the air space. In each case the indicator showed active chlorine in excess of 100 ppm. This observation indicated that the coated zeolite granules released halogen into a confined air space over time.

### Example 2

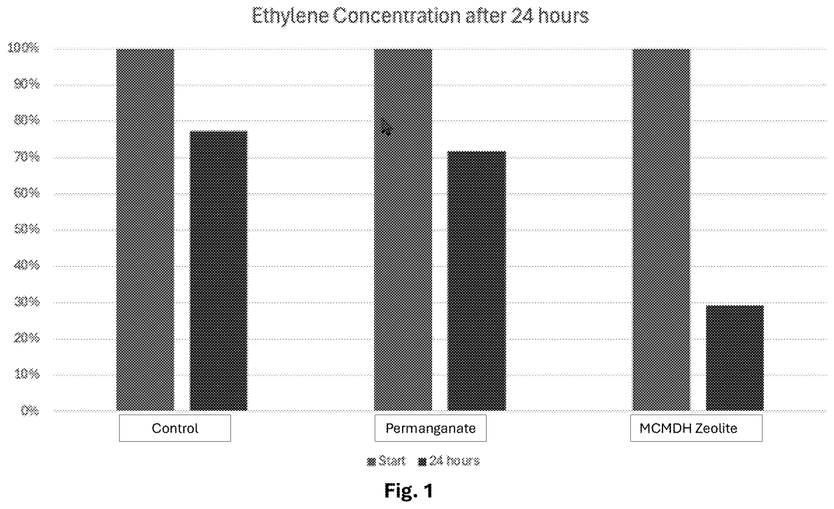

The rate of degradation of ethylene gas in an airspace above a conventional commercial ethylene inactivator (5 μm potassium permanganate (KMnO₄)-coated zeolite granules) was compared to the rate of degradation using an equivalent amount of MCDMH-modified zeolite granules. Samples were in sealed glass sample vials. Ethylene gas in nitrogen was dispensed into the headspace of the respective vials, with one vial serving as control containing no granular material at all. Measurements of ethylene concentration at different time points over 24 hours were accomplished using a gas Chromatography-Mass Spectrometry procedure (Department of Physical Sciences, University of Washington, Bothell Campus, Bothell, WA). FIG. 1 shows the comparative concentrations at 24 hours after ethylene introduction. Some leakage (around 25%) of ethylene from the control vial over the time course of the experiment resulted from serial needle punctures through the seal to obtain samples. Similar leakage can be assumed for test vials as well.

The data indicate that there is a decline in the headspace concentration of ethylene in the presence of potassium permanganate ethylene absorbent but the decline is markedly greater in the vial containing the MCDMH-modified zeolite. Ethylene is absorbed by permanganate, causing a decrease in its concentration in the headspace over time. The higher rate of decline in ethylene in the vial containing MCDMH-modified zeolite is reasonably attributed to neutralization of ethylene in the headspace by volatilized chlorine compositions, which are not produced by permanganate. Ethylene concentration decay was also seen in replicate experiments in which the granules were modified by exposure to dichlorodimethylhydantoin (DCDMH) or monchlorotetramethylimidazolidine-4-one (MC).

### Example 3

The effects of coated zeolite granules in the airspace within a typical plastic lettuce container with a hinged lid on the growth of bacterial populations seeded onto nutrient agar Petri dishes placed within the container was examined. Samples of DCMDH-coated zeolite granules in the amounts of either 2, 5 or 10 grams were placed in open Petri dish lids within the lettuce packages. A small beaker (25 mL) containing 10 mL of water was placed in each plastic container along with an open Petri dish of nutrient agar that was seeded with 100 μL of a suspension of mixed heterotrophic water borne bacteria, typical of those populating municipal potable water at the point of use. Control plastic packages had uncoated zeolite granules in equivalent quantities to the test units, but were otherwise identical.

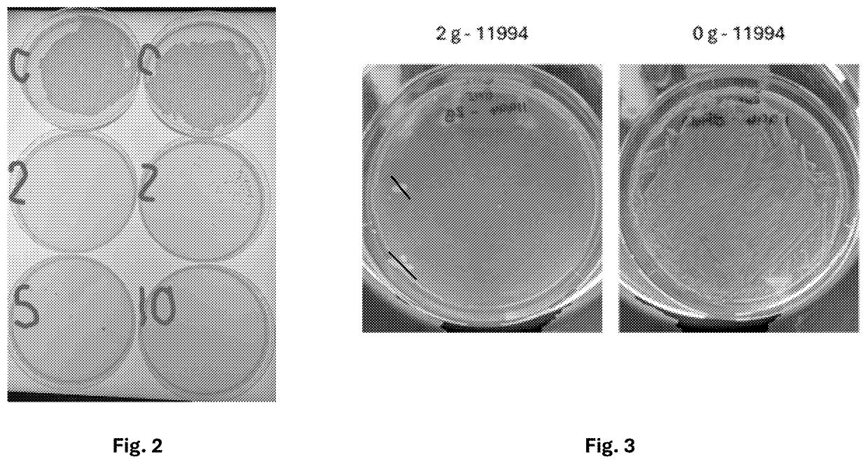

As shown in FIG. 2, after 48 hours of incubation at room temperature there was a high level of inhibition of microbial growth in all test units containing modified zeolite compared to the confluent growth of microbes on the nutrient agar in the control units. These results indicate that zeolites coated with halogenated compounds inhibited growth of bacterial organisms in a confined space typical of packaging used for shipping and retail display of perishable food, and may be used to extend the shelf life of such foods and reduce the chances of bacterial diseases from consuming these foods.

### Example 4

Lawns of bacteria on nutrient agar plates were exposed to headspace in a 1 L plastic lettuce box containing either 0.75 g uncoated zeolite granules (control) or 0.75 g DCDMH-coated zeolite granules. The limit of detection was calculated as 3.3 CFU based on three technical replicates using 0.1 ml of an equilibrated inoculum (1×10⁶ CFU ml⁻¹). Results were based on three biological replicates and are presented in Table 1.

TABLE 1

| | | Final CFU | Log10 | Log |
|---|---|---|---|---|
| Species | Condition | ml⁻¹ [SEM] | CFU ml⁻¹ | reduction |
| S. aureus | Zeolite | 3 × 10⁸ | 8.4 | 0 |
| | | [±8 × 10⁷] | | |
| | Zeolite- | <3.3 | <0.52 | >7.9 |
| | DCDMH | | | |
| L. innocua | Zeolite | 5.3 × 10⁸ | 8.7 | 0 |
| | | [±9.9 × 10⁷] | | |
| | Zeolite- | <3.3 | <0.52 | >8.2 |
| | DCDMH | | | |
| L. | Zeolite | 6.5 × 10⁸ | 8.8 | 0 |
| monocytogenes | | [±1.3 × 10⁷] | | |
| | Zeolite- | <3.3 | <0.52 | >8.2 |
| | DCDMH | | | |
| E. coli | Zeolite | 4.4 × 10⁸ | 8.6 | 0 |
| | | [±1.2 × 10⁷] | | |
| | Zeolite- | <3.3 | <0.52 | >8.1 |
| | DCDMH | | | |

These results show reductions in microbial concentrations of the order of 8 logs, demonstrating the ability of zeolites coated with halogenated compounds to exert antimicrobial effects through air in the headspace in food packaging.

### Example 5

Experiments under conditions described in Example 3 were conducted using the food-borne bacterial pathogen, Listeria monocytogenes. In this experiment 2 μm and 5 μm quantities of DCDMH-modified zeolite granules in porous tea-bag sachets were put into a confined space containing BHI nutrient agar plates seeded with a suspension of Listeria (ATCC strain 11994). As shown in FIG. 3, after 20 hours of incubation at 37 °C, almost complete inhibition of the growth of Listeria was evident in packages containing either 2 or 5 gm of the hydantoin-coated zeolite. These results indicate that zeolite coated with halogenated compounds inhibited growth of pathogenic bacteria on perishable food in a confined space typical of packaging used for shipping and retail display of such perishable food, and may be used to reduce the chances of bacterial diseases from consuming these foods.

In similar experiments in which low levels of Listeria inocula were added to coupons of lettuce leaves and exposed to DCDMH-coated zeolite granules reductions in Listeria was less dramatic, but still much greater than 2 log reduction value (>99%).

### Example 6

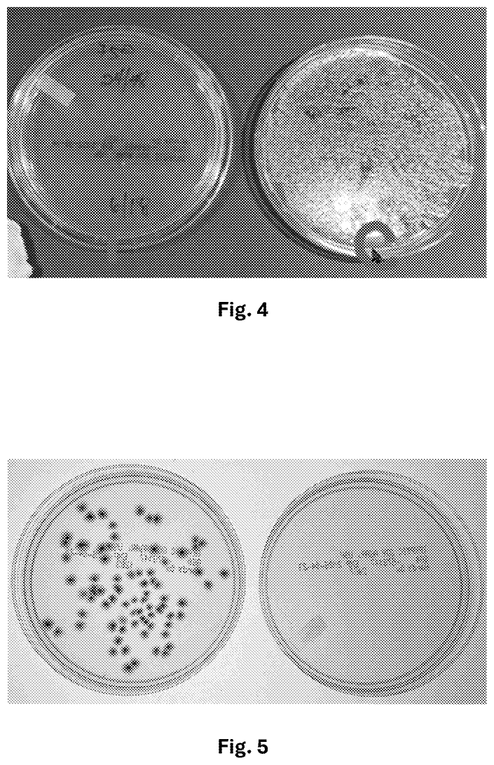

Effects of 750 mg DCDMH-coated zeolite granules on the inhibition of E. coli growth on inoculated agar plates was tested using the same experimental design as Example 5. Moist cotton wool was included in the test boxes to ensure high relative humidity in the headspace. Uncoated zeolite granules were used a control. Results using plates inoculated with E. coli are shown in FIG. 4. The DCDMH-coated zeolite granules substantially reduced bacterial growth.

The packages were opened after 24 hours and the inoculated plates were replaced with freshly inoculated plates to determine if antimicrobial effects persisted. The process was repeated at 48, 72, an 96 hours. In all cases, high log reduction values of E. coli growth continued to be observed with the DCDMH-coated zeolite granules, but not the control granules.

In packages that were vented, and not entirely sealed, were compared to the sealed packages (lettuce boxes), reduction of E. coli was the same, approximately 4.57 log reduction value, after 24 hours incubation at room temperature.

### Example 7

More extensive testing was conducted to evaluate the effectiveness using a superabsorbent polymer material in place of zeolites, and to compare the effectiveness of different halogenated coatings.

A 10 mL headspace vial was purged with 100 ppm ethylene for 15 s. Sample and control vials were treated following the same procedures. Sample vials filled with 750 mg of coated zeolite or commercial permanganate materials and sealed with crimp caps. The ethylene control vial was sealed with a crimp cap. 4 mL of ambient air was removed from each vial using a syringe, then replaced with ethylene. Separate vials were used for measurements at each timepoint after ethylene addition. To test ethylene concentration at each time point (0 h, 2 h, 4 h, 6 h, 24 h) 125 mL of the headspace air was directly injected onto an Agilent 6850 series gas chromatograph with a 0.75×6.35×78.5 mm inlet liner and an HP-PLOT/Q, 30 m×0.320 mm×20 mm column. The inlet temperature was set to 150 °C. The oven settings were set to 50 °C for 4.00 min, the temperature was set to ramp 35 °C/min until oven reaches 220 °C and remained at 220 °C for 3.15 min for a total run time of 12 min. Similar tests may be performed with superabsorbent polymers.

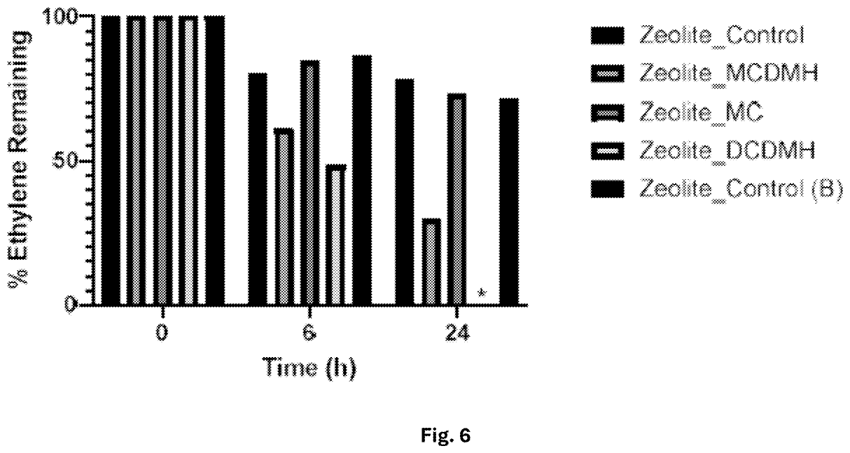

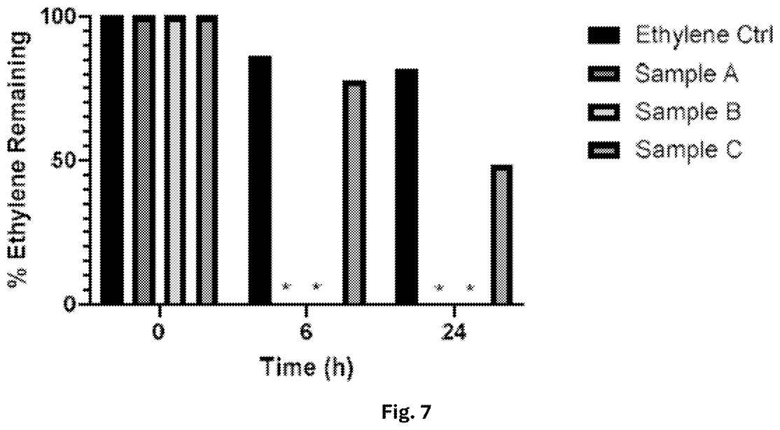

Results, presented in FIGS. 6 and 7, show that zeolite granules coated with halogenated compounds substantially reduced ethylene in the headspace (FIG. 6). Lesser reductions were observed with the commercial permanganate samples (FIG. 7). These results are consistent with Example 1 and further support the improved ability of zeolites coated with halogenated compounds to reduce ethylene in nearby air.

### Example 8

Further testing of antimicrobial activity of coated zeolites was also conducted. Escherichia coli, Listeria innocua, Listeria monocytogenes, and Staphylococcus aureus were routinely cultured on tryptic soy broth (TSB) or agar (TSA). Prior to each experiment a mid-exponential phase culture was equilibrated to an appropriate dose by adjusting the optical density with TSA. Experimental set-up consisted of the following: 0.75 g of zeolite/DCDMH-coated zeolite in either a porous aper sachet or 2 cm² plastic tray, or 1 cm² SAP/DCDMH-coated SAP in a 2 cm² plastic tray; 10 ml sterile distilled water in a Petri dish, without a lid; a lawn-late of bacteria, or 1 g lettuce leaves or whole leaves in a Petri dish, without a lid. These were placed inside a 2 L plastic container with a sealed lid and incubated at either 4 °C, 18-21 °C, or 37 °C. Bacterial growth was determined in the following ways: for lawn plates on agar colony counts were taken where growth was <200 colonies per late. For leaf pieces, transfer to a sterile tube containing 5 ml PBS and vortexed for 60 seconds prior to enumeration by total viable count. For whole leaves, transfer to a fresh plastic container with sterile PBS followed by vigorous agitation-resulting bacterial suspensions were collected and used for enumeration by total viable count. Similar methods were used in Examples 4-6. In some specific experiments, tryptic soy agar (TSA) was inoculated with E. coli, L. innocua, or L. monocytogenes and placed in a sealed 2 L plastic container with either 0.75 g zeolite/DCDMH-coated zeolite. Log reductions of the DCDMH-coated materials vs the uncoated materials were determined after 48 h incubation at 18-21 °C. Results are provided in Table 2 and show antimicrobial effects.

TABLE 2
Log reduction CFU (48 h 18-21 °C)

| 1 × 10⁵ CFU | E. coli | L. innocua | L. monocytogenes | S. aureus |
|---|---|---|---|---|
| DCDMH-zeolite | >8.6 | >8.2 | >8.2 | >7.9 |

Further experiments were conducted with L. monocytogenes to investigate the effect of inoculum dose and temperature on log reduction using 0.75 g DCDMH-coated zeolite, compared to uncoated zeolite. Results are provided in Table 3 and show that higher biological load and physiological temperatures reduced the efficacy of the DCDMH-coated zeolite granules, but antimicrobial effects were still observed.

TABLE 3
Log reduction (48 h)

| DCDMH-zeolite | 1 × 10⁵ CFU | 2 × 10⁷ CFU |
|---|---|---|
| 18-21 °C | >7.6 | 2.5 |
| 37 °C | >7.6 | 6.6 |

All publications, including patent documents, scientific articles, and/or databases referred to in this application, are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

Unless otherwise specified, “includes” may refer to comprises, consists essentially of, or consists of. “Or” is used in the inclusive sense, equivalent to “and/or”.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of reducing food spoilage or food contamination comprising:
placing a chlorinated compound-coated material in an environment of a perishable food item, wherein the chlorinated compound-coated material comprises a chlorinated compound coated on a substrate material, in an amount sufficient to result in release of chlorine gas and hypochlorous acid, but not chlorine dioxide from the chlorinated compound-coated material;
depleting ethylene in the environment of the perishable food item by reaction of ethylene with the chlorine gas, hypochlorous acid, or a chlorinated composition formed therefrom; and
hampering growth of at least one microbial species in the environment of the perishable food item by exposure of the microbial species to the chlorine gas, hypochlorous acid, or a chlorinated composition formed therefrom.

2. The method of claim 1, wherein the chlorinated compound coated on the substrate material comprises a chlorinated imidazolidinedione or imidazolidinone, or any combination thereof.

3. The method of claim 2, wherein the chlorinated imidazolidinedione or imidazolidinone comprises a chlorinated hydantoin.

4. The method of claim 2, wherein the chlorinated imidazolidinedione comprises monochlorodimethylhydantoin (MCDMH), dichlorodimethylhydantoin (DCDMH), or any combinations thereof.

5. The method of claim 2, wherein the chlorinated imidazolidinone comprises monchlorotetramethylimidazolidine-4-one (MC).

6. The method of claim 1, wherein the substrate material comprises a zeolite, bentonite, perlite, vermiculite, sand, alum, fibrous organic materials, superabsorbent polymer, polyacrylate, other organic or inorganic material, or any combinations thereof.

7. The method of claim 6, wherein the substrate material comprises a zeolite, bentonite, vermiculite, perlite, or any combinations thereof.

8. The method of claim 1, wherein placing the chlorinated compound-coated material in the environment of the perishable food item comprises placing a gas-permeable container comprising the chlorinated compound-coated material in the environment of the perishable food item.

9. The method of claim 1, wherein the environment of the perishable food item comprises a sealed, vented, or enclosed package containing the perishable food item.

10. The method of claim 1, wherein ethylene concentration in the air within six inches of the food is reduced by at least 60% within 24 hours after placement of the chlorinated compound-coated material.

11. The method of claim 9, wherein the ethylene concentration in the sealed or enclosed package is reduced by at least 60% within 24 hours after placement of the chlorinated compound-coated material.

12. The method of claim 10, wherein the ethylene reduction remains at least 60% for at least 48 hours after placement of the chlorinated compound-coated material.

13. The method of claim 11, wherein the ethylene reduction remains at least 60% for at least 48 hours after placement of the chlorinated compound-coated material.

14. The method of claim 1, wherein the ethylene reduction slows ethylene-ripening-based spoilage of the perishable food item or ethylene-based ripening of the perishable food item.

15. The method of claim 1, wherein the microbe comprises a bacteria.

16. The method of claim 15, wherein the bacteria comprises E. coli, L. innocua, L. monocytogenes, S. aureus, Salmonella, or any combinations thereof.

17. The method of claim 16, wherein the perishable food item comprises a fruit or vegetable.

18. The method of claim 1, wherein the perishable food item comprises a meat, fish, or shellfish.

19. The method of claim 1, wherein the environment of the perishable food item has a humidity of at least 20%.

20. The method of claim 1, wherein the environment of the perishable food item has a temperature of at least 4 °C.
